(19) United States
(12) Patent Application Publication
(10) Pub. No.: US 2014/0195979 A1
(43) Pub. Date: Jul. 10, 2014

(54) INTERACTIVE USER INTERFACE

(71) Applicant: APPSENSE LIMITED, Warrington (GB)

(72) Inventors: Paul Keith BRANTON, Rochdale (GB); Andrew LEA, Chester (GB)

(73) Assignee: APPSENSE LIMITED, Warrington (GB)

(21) Appl. No.: 13/738,290

(22) Filed: Jan. 10, 2013

(51) Int. Cl. G06F 3/0482

(52) U.S. Cl. CPC G06F 3/0482
USPC 715/834; 715/810

(57) ABSTRACT

A system and method for providing a selection interface on a touch screen device is disclosed. The selection interface depicts a claw for grasping. A progress indicator is provided by varying the motion of the claw. A completion indicator is also provided by depicting the claw in an open state or a closed state, and by moving the claw into a target region.

### BACKGROUND

Various techniques and conventions have been developed over time for providing interfaces to touch screen devices. Touch screens are typically devices that combine a display screen with touch sensors, and are typically operated by touching objects shown on the display screen with one or more fingers, styluses, or other means. These devices can then turn the physical impulses into electrical impulses using capacitive or resistive sensors, which are in turn delivered to a computer or other processing device connected to the touch sensors and to the display screen. Because both the human visual system and the human kinesthetic system are used for the interaction, the effect of some touch screens approximates the sensation of touching and interacting with physical devices in the physical world.

Touch screen interfaces have developed for users on devices that share certain characteristics, which include user interface elements sized for use with the human finger. However, few of these interfaces combine selection and feedback mechanisms elegantly, and many interfaces make it difficult to ensure that a correct action is selected from a list of possible actions, even when using appropriately-sized interface elements. While there are certain touch screen interface “widgets” and controls that are conventional and widely used, there remains a need for innovative touch screen controls that help overcome one or more of these limitations.

### SUMMARY

In accordance with the disclosed subject matter, systems, methods, and non-transitory computer-readable media can provide an interactive user interface. In one embodiment, a computerized method is provided for use with a computing device, comprising: displaying on a touch screen at a first location a tool icon illustrating a tool formed for grasping; displaying on the touch screen at a second location an object icon representing a data object; detecting a touch on the touch screen by a user originating at the first location and ending at the second location; displaying on the touch screen an animation depicting the tool icon grasping the object icon at the second location; translating, on the touch screen, the object icon and the tool icon from the second location toward the first location; and monitoring for at least one of i) additional touches on the touch screen, and ii) a shaking of the computing device.

The touch screen can display at least one of i) an animation of the tool icon moving into an image plane of the touch screen, and ii) an animation of the tool icon moving out of the image plane of the touch screen. An action can be triggered in response to detecting a finger on the touchscreen by the user originating at the first location and a subsequent removal of the finger from the touch screen, thereby allowing the user to change an initially-selected item. Feedback can be provided to the user that represents progress of the action, wherein the feedback includes stopping the translation of the object icon and the tool icon. The translation of the object icon and the tool icon can be stopped when the action is terminated. Terminating the action can be done in response to detecting a shaking motion of the user. The touch screen can display the tool icon in an open state before detecting the touch on the touch screen, and can display, on the touch screen, the tool icon in a closed state after detecting the touch on the touch screen ending at the second location. The object icon can be part of a radial menu and the first location can be at a center of the radial menu. The action can be a request to copy data to the mobile device.

In another embodiment, a computing device is provided, comprising: a touch screen; one or more processors; a computer-readable non-transitory memory coupled to the one or more processors and including instructions that, when executed by the one or more processors, cause the one or more processors to: display on the touch screen a tool icon illustrating a tool formed for grasping, at a first location; display on the touch screen an object icon representing a data object at a second location; detect a touch on the touch screen by a user originating at the first location and ending at the second location; display on the touch screen an animation depicting the tool icon grasping the object icon at the second location; translate, on the touch screen, the object icon and the tool icon from the second location toward the first location; and monitor for at least one of i) additional touches on the touch screen, and ii) a shaking of the computing device.

The instructions can further cause the one or more processors to trigger an action after detecting an ending of the touch originating at the first location. The instructions can further cause the one or more processors to display on the touch screen at least one of i) an animation of the tool icon moving into an image plane of the touch screen, and ii) an animation of the tool icon moving out of the image plane of the touch screen. The instructions can further cause the one or more processors to provide feedback to the user for an underlying operation initiated by the user, the feedback relating to a status of the underlying operation, wherein the feedback is provided by stopping the translation of the object icon and the tool icon. The instructions can further cause the one or more processors to stop the translation of the object icon and the tool icon when the underlying operation is terminated. The instructions can further cause the one or more processors to translate the object icon and the tool icon at a velocity that is a function of a duration of the underlying operation. The instructions can further cause the one or more processors to display, on the touch screen, the tool icon in an open state before detecting the touch on the touch screen, and display, on the touch screen, the tool icon in a closed state after detecting the touch on the touch screen; and wherein the object icon is part of a radial menu and the first location is at a center of the radial menu.

In another embodiment, a non-transitory computer-readable medium is provided, the medium having executable instructions operable to, when executed by a computing device, cause the computing device to: display, on a touch screen, a tool icon illustrating a tool formed for grasping, at a first location; display, on the touch screen, an object icon representing a data object at a second location; detect a touch on the touch screen by a user originating at the first location and ending at the second location; display, on the touch screen, an animation depicting the tool icon grasping the object icon at the second location; translate, on the touch screen, the object icon and the representational image from the second location toward the first location; and monitor for at least one of i) additional touches on the touch screen, and ii) a shaking of the computing device.

The executable instructions can be further operable to cause the computing device to display, on the touch screen, at least one of i) an animation of the tool icon moving into an image plane of the touch screen, and ii) an animation of the tool icon moving out of the image plane of the touch screen; to cause the computing device to provide feedback to the user for an underlying operation initiated by the user, the feedback relating to a status of the underlying operation, wherein the feedback is provided by stopping the translation of the object icon and the tool icon when the underlying operation is terminated; to cause the computing device to terminate the action in response to detecting a shaking motion of the user; to cause the computing device to display, on the touch screen, the tool icon in an open state before detecting the touch on the touch screen; and to display, on the touch screen, the tool icon in a closed state after detecting the touch on the touch screen ending at the second location. The object icon can be part of a radial menu and the first location can be at a center of the radial menu.

### BRIEF DESCRIPTION OF DRAWINGS

FIG. 1 is an exemplary wireframe diagram of a touch screen menu interface.

FIG. 2 is an exemplary wireframe diagram of a touch screen menu interface in an inactive state.

FIG. 3 is an exemplary wireframe diagram of a touch screen menu interface in a claw down state.

FIG. 4 is an exemplary wireframe diagram of a touch screen menu interface in a claw release state.

FIG. 5 is an exemplary wireframe diagram of a claw interface in multiple states.

FIG. 6 is an exemplary system diagram of a mobile touch screen device capable of providing the described touch screen menu interface.

### DETAILED DESCRIPTION

In the following description, specific details are set forth regarding the systems and methods of the disclosed subject matter and the environment in which such systems and methods may operate in order to provide a thorough understanding of the disclosed subject matter. It will be apparent to one skilled in the art, however, that the disclosed subject matter may be practiced without such specific details, and that certain features well-known in the art are not described in detail in order to avoid unnecessary complication of the disclosed subject matter. In addition, it will be understood that the embodiments provided below are exemplary, and that other systems and methods are contemplated and within the scope of the disclosed subject matter.

Embodiments are described herein of techniques for providing a selection interface on a touch screen device. The selection interface can depict a claw for grasping. A user can “grab” information to import onto the mobile device by grabbing the information using the virtual claw. The selection interface can be animated in such a matter that it conveys the progress of the download process. For example, the claw can slowly return to a “home” position from a “remote” position as a desired file downloads. A completion indicator can also be provided by depicting the claw in an open state or a closed state, and by moving the claw into a target region. Other embodiments are within the scope of the subject matter disclosed herein.

A user interface element can be called a widget. Widgets can be developed with the awareness that mobile user interfaces have limitations inherent to the touch screen medium. These limitations can include available screen area, since if a button is too large, it will obscure relevant data; the size of the finger, which is the most common means for interaction; and the limited ability to provide “tool tips” or other in-line help information. Examples of user interface widgets include: vertical lists of files, icon lists of files organized in a grid, actions rendered as buttons, and progress bars to provide feedback for continuing operations. Each of the foregoing widgets can be adapted for use on a touch screen on a multi-tasking device (e.g., to handle a situation where an application is placed into an inactive state due to, for example, an incoming phone call).

Typical user interface widgets that are used in desktop operating systems can be difficult to carry over to a mobile touch screen interface. For example, icons organized in a grid are commonly used by desktop operating systems to represent files. Certain operations can be performed in the operating system using click and drag interactions. For example, dragging one icon onto another target icon can result in a copy or move of a file to a new location. However, on a mobile device, the area displayed on screen is typically smaller than that displayed on a desktop device. This results in fewer potential target icons when dragging icons onto target icons, or if the same number of target icons are displayed, the icons are displayed at a small size that increases the difficulty of the interaction.

To address some of these challenges, a new user interface element or widget can be provided that includes a number of desirable attributes, such as natural feedback and gamification. The feedback needed can be provided in a way that is entertaining and satisfying to the user, while still being tied to the underlying operation of the system. The user can be informed of approximately how long the operation will take to complete, how much progress has been made and, ultimately, if the operation was successful. One method of providing feedback can include using a “claw” to interact with objects on the user interface (e.g., using the claw to effectuate copying or moving data from a remote location to the mobile device).

An aspect of the user interface widget disclosed herein can be gamification. Gamification is a general term for the use of game design techniques in non-game contexts, and is often used to make user interactions more engaging, entertaining, or pleasant. An example of gamification is the use of reward points as rewards for users who perform certain actions or behaviors. When users receive rewards for performance, users can see and track their progress, and can also set and achieve goals, thereby helping to make non-game interactions more engaging. In some embodiments of the user interface widget described herein, gamification is provided by, for example, requiring the user to drag his or her finger to the target carefully, and providing graphics, sounds and/or animations that show an animated claw grasping and dropping an object, to evoke pleasant memories of, for example, a carnival game. When memories of childhood fun are evoked, a user can be engaged at a deeper, emotional level, thereby creating an affinity for a product using this interface. In place of a claw, other tool icons or representations of tools can be used, including, for example, hammers, saws, lasers, microscopes, robotic fingers, hands, arms, legs, feet, or appendages, and representations of animal appendages.

Another aspect of the user interface widget disclosed herein can be the mapping of function to appearance. Many users have heightened expectations for the usability of user interface widgets on mobile devices. This can be due to the fact that mobile interfaces can sometimes be used in varied and demanding environments, i.e., used with one hand, without full user attention, or in other environments. This can also be due to the fact that mobile applications are expected to be operable without extensive training, as was typically made available for desktop applications. User interfaces that intuitively indicate their function by their appearance can have an advantage over interfaces that require training or documentation to explain their use. In some embodiments of the user interface widget described herein, the appearance of the widget as a claw suggests that its function is for grasping, and for moving objects from one location to another.

The described user interface widget can be configured to provide user feedback in a manner different from, for example, a progress bar. Progress bars are usually rectangular in shape, and show an outer rectangle, representing a meter or gauge, that contains an inner rectangle, representing the current status of the meter or gauge, and thereby representing the progress of a continuing operation. However, in the small screen context of mobile devices, progress bars provide information in a way that can be intrusive, takes up screen space, and can be irrelevant to the current context of the user. In some embodiments of the user interface widget described herein, feedback about a currently-running operation can be provided in a non-intrusive, intuitive way via the animated motion of the claw as it travels between a source and a target on the screen. This can provide the needed information without a progress bar.

Feedback can be provided for the progress of an operation in some embodiments using, for example, the position and velocity of the claw as it moves translationally from a source to a target. When used in showing the progress of a data transfer operation, the position of the claw itself can represent, or indicate, the degree of completion of the data transfer. The claw being positioned at the source can indicate zero percent completion, and the claw being positioned at the target can indicate one hundred percent completion. Since the position can indicate the degree to which a data transfer operation is complete, when the position changes rapidly, the velocity can represent the velocity of data transfer from the source to the target. The change in position can reflect, for example, approximately or exactly how long an operation will take to complete, or how much progress has been made. Feedback can be provided for when an operation terminates abruptly or in an error condition by, for example, showing the claw abruptly terminating its motion while moving to the target location.

Feedback can also be provided using the continued motion of the claw, in some embodiments. Progress bars can indicate that an operation is continuing by showing a visual element, for example, the inner rectangle, continuing to be in motion. This can be provided in a similar fashion by showing the claw in continuous motion. The claw can move translationally between an origin to a destination. The claw can also show continuous motion by moving arms on the claw, for example, by showing extension and contraction of the arms. This motion can be performed to show that an operation is still in progress when data is being transferred, or when data is not being transferred.

Feedback can also be provided using motion of the claw into or out of the image plane, in some embodiments. The claw is conceptually a three-dimensional object, and can move up and down in relation to the image plane (or the plane of the touch screen), in addition to moving translationally across the plane of the touch screen. This motion mimics a physical claw, and can enhance the user's understanding of operations performed by the claw, such as, for example, showing that an item is being selected by animating the claw moving “down” into the image plane, grasping the item, and animating the claw moving “up” out of the image plane. This animated motion can provide feedback to the user that an item has been selected.

Another aspect of the user interface widget disclosed herein can be the combination and integration of feedback and action selection. For example, direct manipulation of the user interface can be combined with feedback. Direct manipulation can involve continuous representation of objects of interest, and rapid and incremental feedback for actions. For example, windows on mobile devices can be scrolled by dragging or swiping a finger on the touch screen. This can result in rapid motion of the window contents in the direction of the swipe. The user can be enabled to intuitively and effectively use this interface by the presence of rapid feedback.

In some embodiments of the user interface widget described herein, selecting the action can result in immediate feedback at the time and screen location where the selection occurs. As one example, selecting a file to be copied can involve dragging the claw to the file and dropping the claw on the file. If the file cannot be selected, the claw will be unable to pick up the file and will display an animation showing an empty claw. Since the user is directly manipulating the claw, the user can revert his or her action before the claw is dropped on the target, in some embodiments, merely by moving the finger away from the target. As another example, files can be selected to be copied to the mobile device. This operation can be initiated by dragging the claw to the file to be selected. During the operation, as described above, the motion of the claw can provide feedback to the user indicating that the file is currently being copied. The user is thereby given immediate and effective feedback in a way that naturally arises from the action selection operation, thereby intuitively showing the user the status of the currently-pending operation.

In some embodiments, the system can respond to user input (e.g., gestures, shakes, etc.) to modify an in-progress operation. For example, the operation that results from the user action (e.g., the copying of a file) can be canceled and/or aborted. Canceling and aborting can be performed while the operation is in progress, and can be initiated by touches or other physical movements from a user during the operation (e.g., while the claw is in motion from the source to the target). Canceling can include situations where a represented operation is terminated before it is initiated at the target system (e.g., before the target system begins to receive a file). Aborting can include situations where a represented operation is terminated after it is initiated, or when the operation is already in progress (e.g., while the file is being copied). Canceling and aborting can be triggered by one of the following user interactions: shaking the device; touching or releasing a location on the touch screen; tracing a gesture on the touch screen, such as an “X” gesture; performing a “flick” gesture, which can be performed at the location of the claw, or elsewhere; or by another interaction. The canceling and aborting can result in a change in the displayed visual state, such as the claw dropping a grabbed item that represents the operation and/or object, the grabbed item being “shaken loose” from the claw, and/or the claw simply returning back to an open state. Canceling and aborting can be user-initiated.

In some embodiments, the described change in displayed state (e.g., the claw “dropping” an item) can be indicative of a failed operation (e.g., one that was not the result of user action). In some embodiments, a verbal message or other clarifying message can be displayed indicating that an operation has failed, thereby allowing a user to understand that the operation has failed even if he or she has left the device in an unattended state.

In some embodiments, touches from a user during the progress of an operation, such as, for example, holding a finger on the claw, can cause a data transfer to pause.

Another aspect of the user interface widget disclosed herein is the use of radial menus, which are also called pie menus. On handheld, touch screen devices with relatively small displays, it is sometimes difficult to ensure the correct action is selected from a list of possible actions, because the action is provided using a small button. In other cases, some menu options are not visible on screen because of limited screen area, requiring a user to both remember menu options which are not visible, and also to manipulate the screen in order to show these options. Radial menus solve some of these issues by presenting menu items arranged in a circular fashion around a touch/click target. Selection of a menu item is performed by the user moving a cursor or finger to the appropriate section of the circle to make your selection.

Radial menus can have many benefits, including, for example, short distance to selection targets; equal distance to each target; no scrolling all the way to the bottom of a dropdown menu; the visibility of many options at once, which allows for little or no short-term memory load. Radial menus can also enable the use of muscle memory over long term memory. After learning the location of each menu option, a user is able to use swipe gestures without looking at the location of the screen to activate the control. This can allow for natural, intuitive touch operation.

The user interface described herein uses, in some embodiments, a circular arrangement of selection options. The center of a circle that takes up a large area on the touch screen (the “selection circle”) can be designated as an initial location for the claw. The area around the claw can be divided equally into slices or wedges, such that the actions that are selectable using the claw are arranged around the outside of the selection circle. Using the outside of the selection circle allows the actions to have relatively large target areas for a user's finger during touch screen operation.

The user interface described herein can be appropriate for providing an interface to various operations. One example of an operation that can be represented and controlled using this interface is called “pull-and-paste,” and involves allowing a user on a mobile device to download one or more data objects from other computers or from the Internet to his or her local device. In some embodiments, the claw user interface can visually represent the actions of selecting, copying, and downloading data objects to the local device.

An exemplary operation of the user interface is now described. Operation of a widget can be separated into four phases: initial; selection; progress; and termination. In the initial phase, before the selection phase, the claw can be in an initial location, which in some embodiments is in the center of the touch screen. The claw can also be in a visual state that represents that the claw is able to perform grasping tasks, which can show claws in a neutral or open state, or in a closed state, but reflects the absence of any object being grasped by the claw.

In the selection phase, the user can manipulate a visual depiction of a “claw” via the device's touch screen and guide it over the desired action. The claw selection mechanism can be used to “grab” information from a PC onto a mobile device. In general, operations that involve copying or moving data to the current device are well-suited for this user interface. In some embodiments, the action can be initiated when the user places his or her finger on the touch screen. In other embodiments, the action can be initiated after the user takes finger off the touch screen, thereby allowing a user to abandon his or her first choice and/or choose another item if desired.

In the progress phase, the claw can appear to grasp the action and begin to return to its starting position. The speed at which the claw returns and distance it travels can be representative of the progress being made in completing the action. However, the action may terminate unexpectedly, in which case the user interface should reflect this by dropping the action being grasped while it is in motion to the starting position; the claw returning to the initial position without the action; and the action also returning to its pre-grasped position.

In the termination phase, and if the action completes successfully, the claw can return fully to its starting position while maintaining its grasp on the action. In some embodiments, the action is dropped from the claw and disappears, and the claw returns to a visual state indicating that it is ready to perform additional actions. In the termination phase in the case that the action fails, the “claw” releases its grasp and returns to the initial position and the ready visual state.

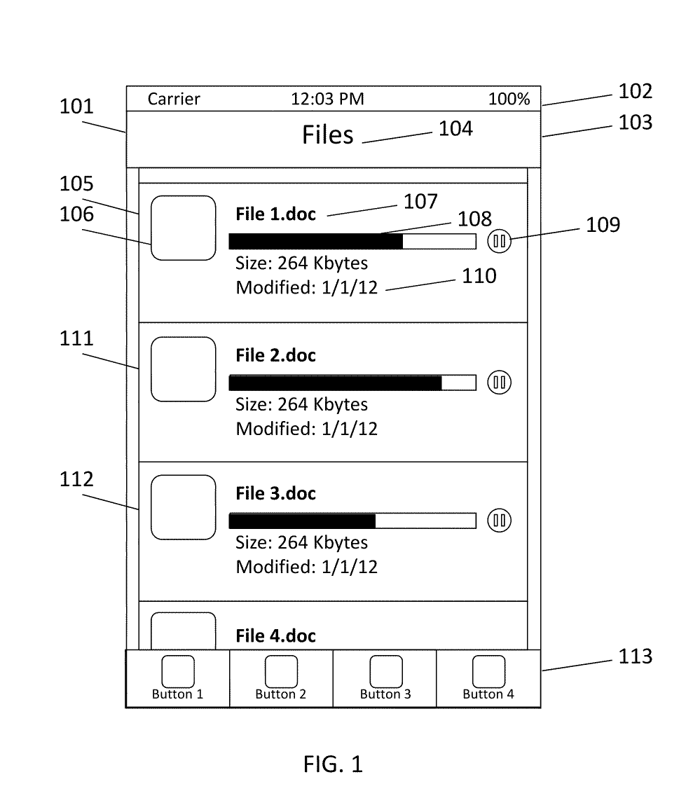

FIG. 1 is an exemplary wireframe diagram of a touch screen menu interface known in the prior art. View 101 represents the full viewable area on a mobile device, such as an Apple iOS iPhone® device, or a mobile device running the open source Android® operating system. Status bar 102 can display status information for the mobile device, such as a cell network provider logo and signal strength indicator, the current time, and the level of charge of a battery of the mobile device. Title bar 103 includes title 104, where title 104 describes and characterizes the content shown on the rest of the screen.

Below title bar 103 are multiple rows 105, 111, 112, each associated with a single file or data object. Icon 106 represents an individual file, and text 107 and text 110 represent information about the file, such that each element in row 105 represents information about the same single file. Also part of row 105 are progress bar 108 and cancel/pause button 109. Progress bar 108 is a standard progress bar that indicates the progress of a currently-running operation relating to this file.

Cancel/pause button 109 is a button that allows for actions to be taken on the currently-running operation; the icon on the button shown in FIG. 1 reflects a “pause” action, but different operations can be mapped to this button, including a “cancel” action to cancel the currently-running operation. Given that much of the available screen space is given to the progress bar 108, there is little room for buttons, and only a small number of buttons can be provided in this location.

At the bottom of the screen is a row of buttons 113 that can represent modes of an application, or that can represent functionality that is not related to the functionality in the main area of the screen.

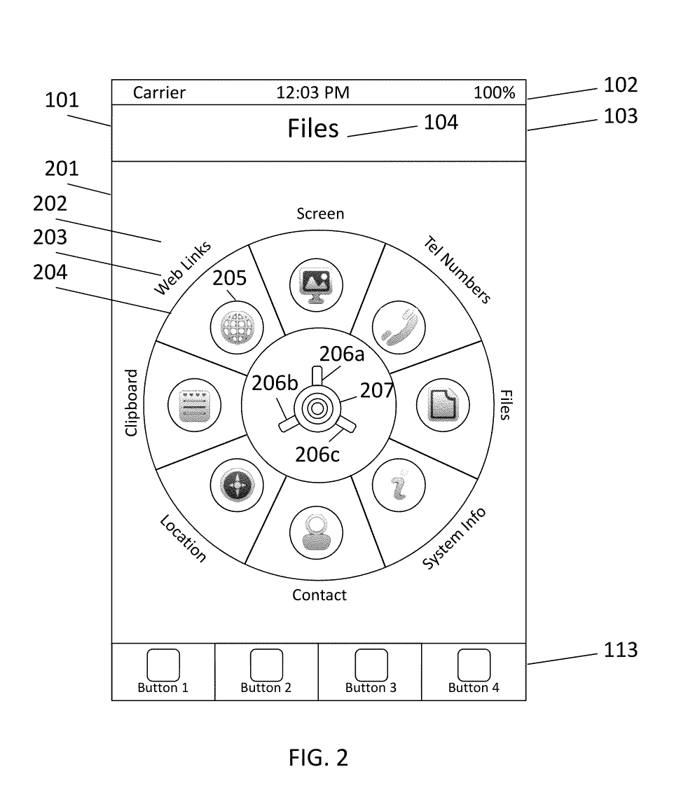

FIG. 2 is an exemplary wireframe diagram of a touch screen menu interface in an inactive state. View 101 represents the full viewable area on the mobile device. Status bar 102 displays status information for the mobile device. Title bar 103 includes title 104, where title 104 describes and characterizes the content shown on the rest of the screen. A row of buttons 113 is provided as well, as described in reference to FIG. 1.

Display area 201 contains radial menu 202, which in turn contains radial menu item 204. Further radial menu items are also shown. Each radial menu item is a radial slice of the circular area comprising the radial menu. The radial menu items can each include a radial menu item text label 203 and a radial menu item icon 205.

Radial menu 202 can contain an arbitrary number of menu items. In some embodiments, the number of menu items can be between five and nine items, corresponding to the well-studied ability of the human brain to accommodate approximately seven items in short-term working memory. This number also ensures that on a space-limited mobile device, the screen area used for each button is large enough to be manipulated or touched or used as a drag target by the user.

The contents of radial menu 202 can include data sources from which the user may select to “pick up” data using the claw interface. The availability of a menu item can be reflected using color, by showing the icon within the menu item area, or by other means. The data from the data sources can thus be selected for copying to the user's mobile device. These data sources can be, for example, computing devices or hosts; types of information stored on a remote device; types of information to be synchronized with the local device; or other information. Radial menu item icon 205 is a graphical icon representing a data source; radial menu item text label 203 also represents the data source.

In some embodiments, in the center of radial menu 202 is claw 207, with claw arms 206a, 206b, 206c . In operation, the size and shape of claw 207 and claw arms 206a, 206b, 206c can be changed, and the change can be animated. Initially the claw can be in a default state and position in the center of radial menu 202. Claw feet 206a, 206b, 206c can be in a retracted state, or in an extended state, or a default state that is neither retracted nor extended. In some embodiments, when the user touches claw 207, the claw appears to elevate from its position in the center of radial menu 202. A shadow can be displayed beneath the claw. While the user holds his or her finger on the position of the claw, the claw remains in the elevated state and follows the motion of the finger as it is moved or dragged across the touch screen. When the claw enters the elevated state, in some embodiments claw feet 206a, 206b, 206c can remain in their original state or enter an extended state.

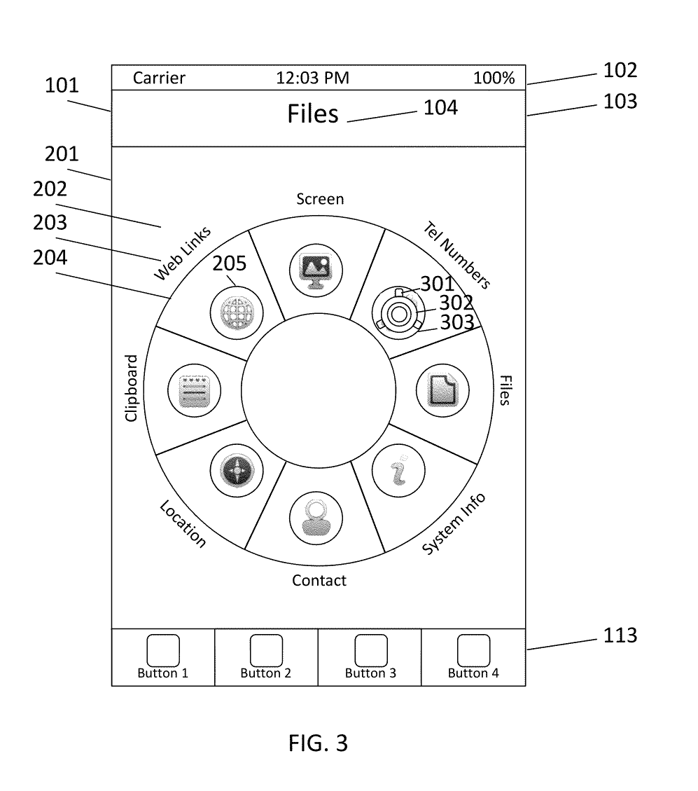

FIG. 3 is an exemplary wireframe diagram of a touch screen menu interface in a claw down state. View 101 represents the full viewable area on the mobile device. Status bar 102 displays status information for the mobile device. Title bar 103 includes title 104, and row of buttons 113 is provided as well, as described in reference to FIG. 1. Display area 201 contains radial menu 202, which in turn contains radial menu item 204, radial menu item text label 203 and radial menu item icon 205. Claw 302 is shown connected to claw feet 301 and overlapping selected radial menu item icon 303.

In some embodiments, when the user removes his or her finger from the touch screen, claw 302 is shown as descending from the elevated state described above in reference to claw 207. In the depicted situation, claw 302 is over a menu item, and when the user's finger is released, claw 302 descends onto menu icon 303 and an animation can be shown of claw feet 301 grasping selected radial menu item icon 303.

In some embodiments, claw 302 may select menu icon 303 even if the user does not exactly place claw 302 over the icon. If the user selects the menu item by placing claw 302 over any part of the radial menu item 204, the claw may correctly pick up the selected menu item icon. In some embodiments, the selectable area may include text labels 203.

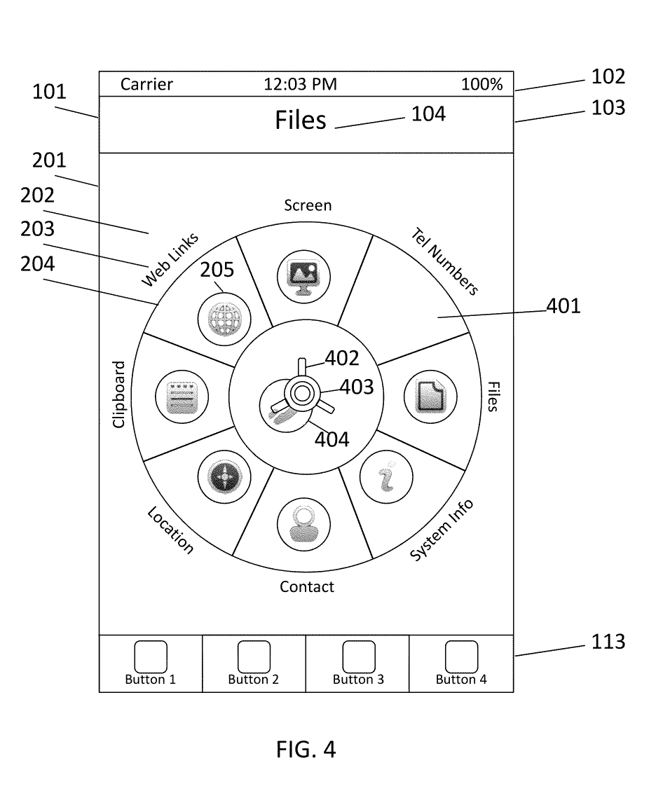

FIG. 4 is an exemplary wireframe diagram of a touch screen menu interface in a claw release state. View 101 represents the full viewable area on the mobile device. Status bar 102 displays status information for the mobile device. Title bar 103 includes title 104, and row of buttons 113 is provided as well, as described in reference to FIG. 1. Display area 201 contains radial menu 202, which in turn contains radial menu item 204, radial menu item text label 203 and radial menu item icon 205.

In some embodiments, once the user's finger has been removed, the claw is no longer under the user's direct control. This can be referred to as a claw release state. Claw 403 can move automatically to the center of radial menu 202. Once it moves to the center of the radial menu, as depicted, claw feet 402 can be animated to extend, and selected menu item 404 drops from the claw and can be animated as it falls from the claw into the center of radial menu 202. This can reflect completion of an underlying copy operation. In some embodiments, selected menu item 404 can disappear once dropped; in other embodiments, it can remain in the center. In some embodiments, menu area 401, which was the source of selected menu item 404, can be shown as an empty space; in other embodiments, menu area 401 may be displayed with the menu item grayed out, or another indication may be shown reflecting its unavailability.

In some embodiments, the speed at which claw 403 moves can reflect the time required to perform an underlying copy operation of data from the data source to the user's mobile device. If the copy operation stops, the motion of the claw can stop. If the copy operation fails, the claw can be shown to drop the selected menu icon 404 and can return to the center of radial menu 202, its default location. In some cases, the user may not be monitoring the state of the copy operation. To accommodate this user interaction model, in some embodiments the application may show an alert or notification describing the aborted copy operation. In some embodiments, the user can touch claw 403 while it is in motion to cause the copy operation to be cancelled or paused.

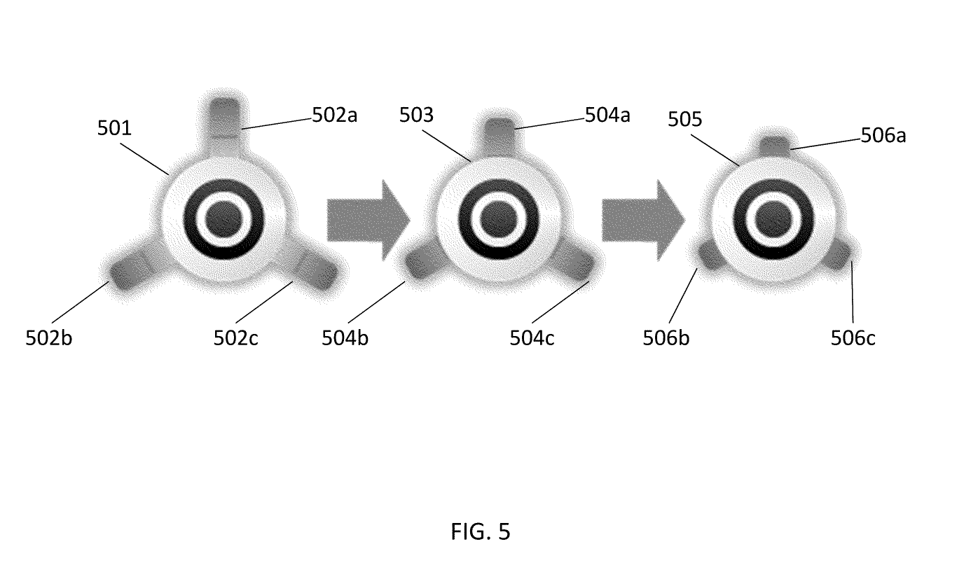

FIG. 5 is an exemplary wireframe diagram of a claw interface in multiple states. Claw 501 and claw feet 502a, 502b, 502c are shown in an extended state. This state can be shown briefly before and during the selection of an object or icon. Claw 503 and claw feet 504a, 504b, 504c are shown in a neutral state. This state can be shown when the state of the claw feet is otherwise not specified, such as when the claw is resting in the center of the radial menu, or when the claw is returning to the center of the radial menu without grasping an object or icon. Claw 505 and claw feet 506a, 506b, 506c are shown in a grasping state. This state can be displayed to indicate that the claw is holding an object or icon. The held object or icon may also be shown in a manner reflective of its state, i.e., shown obscured by claw 505. In some embodiments, transitions between these states can be animated.

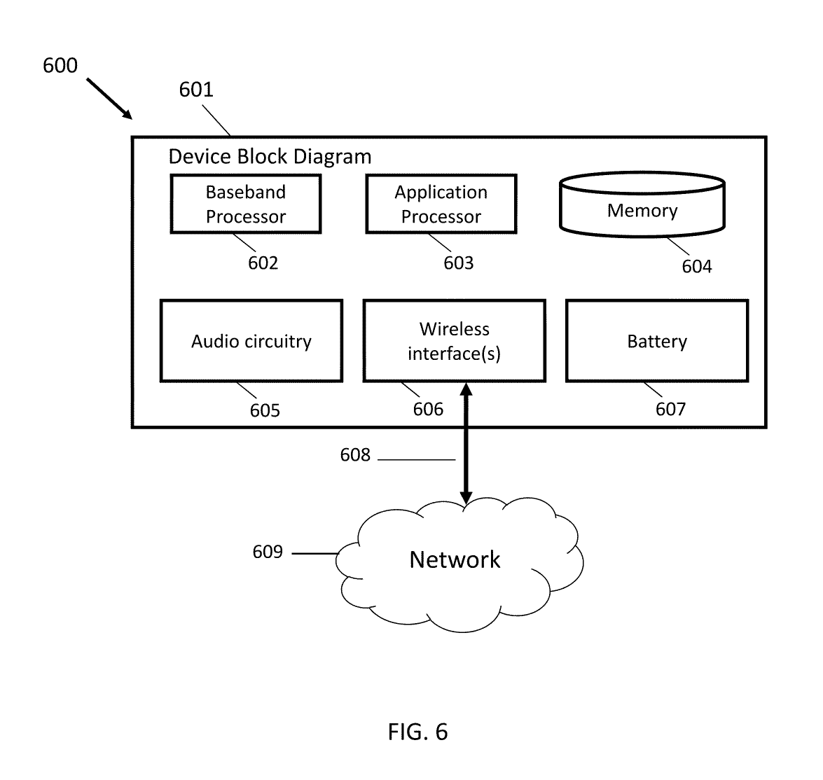

FIG. 6 is an exemplary system diagram of a mobile touch screen device capable of providing the described touch screen menu interface. Device block diagram 601 includes baseband processor 602, application processor 603, memory 604, touch screen 605, wireless interface(s) 606, and battery 607. Additional capabilities and functions can be present within the mobile touch screen device, including but not limited to: wired communications UART modules, serial communications modules, audio playback circuitry, audio compression and coding circuitry, digital signal processing modules, power amplifiers, and one or more antennas.

Wireless interface(s) 606 can include interfaces for one or more of the following wireless technologies: 802.11b, a, g, n; UMTS; CDMA; WCDMA; OFDM; LTE; WiMax; Bluetooth; or other wireless technology, and can use one or more antennas (not shown) or other means to communicate with network 608. Baseband processor 602 can be used to perform telecommunications functions, such as channel coding, and to interface with the wireless interface(s) 606.

Application processor 603 can run operating system software and application software, and can be a general-purpose microprocessor using an instruction set from Intel Corporation, AMD Corporation, or licensed from ARM Inc. The processor can include graphics capabilities for providing pixel data for display on touch screen 605, or graphics capabilities can be provided by a separate graphics coprocessor. Touch screen 605 can include touch detection circuitry, and can include display circuitry.

Memory 604 can store working instructions and data for one or both of application processor 603 and baseband processor 602, in addition to storing data, files, music, pictures, or other data to be used by the mobile device and/or its user, and can be a flash memory, a programmable read-only memory (PROM), a read-only memory (ROM), or any other memory or combination of memories. An operating system stored in memory 604 can include device management functionality for managing the touch screen and other components.

Battery 607 is controlled by application processor 603 and provides electrical power to the mobile device when not connected to a power source. Network 609 can be a cellular telephone network, a home or public WiFi network, the public Internet via one or more of the above, or another network.

The mobile touch screen device can be an Apple iPhone® or iPod® or iPad® or other iOS® device, or a device using the Android® operating system, or a device using the Windows® operating system for mobile devices. The mobile touch screen device can include cellular telephony capabilities.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

In addition to the embodiments described above, various alternatives are contemplated, including automatic or dynamic ordering of menu items; automatically resizing interface elements for tablet and landscape orientation interfaces; providing contextual menu items for non-table row implementations, where the handles are still placed in proximity to an icon representing a data object and used to provide access to the contextual menu for that data object; multiple nesting of contextual menus, in which some of the action buttons also have handles for opening and closing contextual menus on the action buttons themselves; and other alternatives.

What is claimed is:

1. A computerized method for use with a computing device, comprising:
displaying on a touch screen at a first location a tool icon illustrating a tool formed for grasping;
displaying on the touch screen at a second location an object icon representing a data object;
detecting a touch on the touch screen by a user originating at the first location and ending at the second location;
displaying on the touch screen an animation depicting the tool icon grasping the object icon at the second location;
translating, on the touch screen, the object icon and the tool icon from the second location toward the first location; and
monitoring for at least one of i) additional touches on the touch screen, and ii) a shaking of the computing device.

2. The computerized method of claim 1, further comprising displaying on the touch screen at least one of i) an animation of the tool icon moving into an image plane of the touch screen, and ii) an animation of the tool icon moving out of the image plane of the touch screen.

3. The computerized method of claim 1, further comprising:
triggering an action in response to detecting a finger on the touchscreen by the user originating at the first location and a subsequent removal of the finger from the touch screen, thereby allowing the user to change an initially-selected item; and
providing feedback to the user that represents progress of the action, wherein the feedback includes stopping the translation of the object icon and the tool icon.

4. The computerized method of claim 3, wherein the translation of the object icon and the tool icon is stopped when the action is terminated.

5. The computerized method of claim 1, further comprising terminating the action in response to detecting a shaking motion of the user.

6. The computerized method of claim 1, further comprising displaying, on the touch screen, the tool icon in an open state before detecting the touch on the touch screen, and displaying, on the touch screen, the tool icon in a closed state after detecting the touch on the touch screen ending at the second location.

7. The computerized method of claim 1, wherein the object icon is part of a radial menu and the first location is at a center of the radial menu.

8. The computerized method of claim 3, wherein the action is a request to copy data to the mobile device.

9. A computing device, comprising:
a touch screen;
one or more processors;
a computer-readable non-transitory memory coupled to the one or more processors and including instructions that, when executed by the one or more processors, cause the one or more processors to:
display on the touch screen a tool icon illustrating a tool formed for grasping, at a first location;
display on the touch screen an object icon representing a data object at a second location;
detect a touch on the touch screen by a user originating at the first location and ending at the second location;
display on the touch screen an animation depicting the tool icon grasping the object icon at the second location;
translate, on the touch screen, the object icon and the tool icon from the second location toward the first location; and
monitor for at least one of i) additional touches on the touch screen, and ii) a shaking of the computing device.

10. The computing device of claim 9, wherein the instructions further cause the one or more processors to trigger an action after detecting an ending of the touch originating at the first location.

11. The computing device of claim 9, wherein the instructions further cause the one or more processors to display on the touch screen at least one of i) an animation of the tool icon moving into an image plane of the touch screen, and ii) an animation of the tool icon moving out of the image plane of the touch screen.

12. The computing device of claim 9, wherein the instructions further cause the one or more processors to provide feedback to the user for an underlying operation initiated by the user, the feedback relating to a status of the underlying operation, wherein the feedback is provided by stopping the translation of the object icon and the tool icon.

13. The computing device of claim 12, wherein the instructions further cause the one or more processors to stop the translation of the object icon and the tool icon when the underlying operation is terminated.

14. The computing device of claim 12, wherein the instructions further cause the one or more processors to translate the object icon and the tool icon at a velocity that is a function of a duration of the underlying operation.

15. The computing device of claim 9, wherein the instructions further cause the one or more processors to display, on the touch screen, the tool icon in an open state before detecting the touch on the touch screen, and display, on the touch screen, the tool icon in a closed state after detecting the touch on the touch screen; and
wherein the object icon is part of a radial menu and the first location is at a center of the radial menu.

16. A non-transitory computer-readable medium having executable instructions operable to, when executed by a computing device, cause the computing device to:
display, on a touch screen, a tool icon illustrating a tool formed for grasping, at a first location;
display, on the touch screen, an object icon representing a data object at a second location;
detect a touch on the touch screen by a user originating at the first location and ending at the second location;
display, on the touch screen, an animation depicting the tool icon grasping the object icon at the second location;
translate, on the touch screen, the object icon and the representational image from the second location toward the first location; and
monitor for at least one of i) additional touches on the touch screen, and ii) a shaking of the computing device.

17. The non-transitory computer-readable medium of claim 15, the executable instructions further operable to cause the computing device to display, on the touch screen, at least one of i) an animation of the tool icon moving into an image plane of the touch screen, and ii) an animation of the tool icon moving out of the image plane of the touch screen.

18. The non-transitory computer-readable medium of claim 15, the executable instructions further operable to cause the computing device to provide feedback to the user for an underlying operation initiated by the user, the feedback relating to a status of the underlying operation, wherein the feedback is provided by stopping the translation of the object icon and the tool icon when the underlying operation is terminated.

19. The non-transitory computer-readable medium of claim 17, the executable instructions further operable to cause the computing device to terminate the action in response to detecting a shaking motion of the user.

20. The non-transitory computer-readable medium of claim 15, the executable instructions further operable to cause the computing device to display, on the touch screen, the tool icon in an open state before detecting the touch on the touch screen, and to display, on the touch screen, the tool icon in a closed state after detecting the touch on the touch screen ending at the second location; and
wherein the object icon is part of a radial menu and the first location is at a center of the radial menu.
